(19) United States
(12) Patent Application Publication
(10) Pub. No.: US 2006/0267731 A1
(43) Pub. Date: Nov. 30, 2006

(54) System and apparatus of Internet-linked RFID sensor network for object identifying, sensing, monitoring, tracking and networking

(76) Inventor: Thomas C. H. Chen, Houston, TX (US)

Correspondence Address: Thomas C. H. Chen, 5468 Cedar Creek Dr., Houston, TX, 77056, US

(21) Appl. No.: 11/141,762

(22) Filed: May 31, 2005

(51) Int. Cl. H04Q 5/22

(52) U.S. Cl. 340/10.1; 340/572.1; 340/539.22

(57) ABSTRACT

An Internet-linked RFID Sensor Network (iRfidSensorNet) system that uses sensors, RFID tags, RFID readers, intelligent-agent-based software, wireless and landline communication networks, and Internet, Intranet, Extranet links for continually identifying, sensing, monitoring, tracking and networking of multiple clusters of objects that are either at stationary location or on the move, and communicating autonomously among these object clusters within the iRfidSensorNet's accessible range. The iRfidSensorNet system comprises a plurality of Wireless RFID/Sensor Tag Apparatus 200 for identifying, sensing and measuring object conditions, and a RFID Reader Apparatus 100 containing System Software 300 that uses an active, real-time concurrent method to process object's conditions and location information for providing an alert to be transmitted to a remote monitoring station for immediate attention.

### BACKGROUND

1. Field of Invention

This invention relates in general to Radio-Frequency Identification (RFID) and sensor, and in particular to an Internet-linked RFID Sensor Network (iRfidSensorNet) system that uses sensors, RFID tags, RFID readers, wireless communication networks, intelligent-agent-based software, and Internet, Intranet, and Extranet links for continually identifying, sensing, monitoring, tracking and networking of multiple clusters of objects that are either at a stationary location or on the move, and communicating autonomously among these object clusters within the accessible range of iRfidSensorNet.

2. Description of Related Art

The RFID technology is well understood in the art. A RFID system consists of a reader that includes RF transmitter and receiver (transceiver), and multiple RFID transponder tags that include an antenna for communicating with the RFID reader. The RFID reader uses radio transmission to send energy to the RFID transponder tag, which in turn emits a unique identification code back to the reader. The frequencies used by RFID technology are varied ranging from 50 KHz to 2.5 GHz. RFID transponder tags come in three basic forms: passive RFID transponder tag, battery assisted passive RFID transponder tag and active RFID transponder tag. Passive RFID transponder is a tag that does not contain a battery. The power is supplied by the RFID reader. When radio waves from the RFID reader are encountered by a passive RFID transponder tag, the coiled antenna within the tag forms a magnetic field. The passive RFID transponder tag draws power from it, energizing the circuits in the tag. The passive RFID transponder tag then sends the information encoded in the tag's memory back to the RFID reader. Battery-assisted passive RFID transponder is a tag that also reflects signal back to the RFID reader but use an on-board battery to either boost the tag's read range or to run the circuitry on the chip or a sensor integrated with the transponder tag. Active RFID transponder is a tag when it is equipped with a battery that can be used as a partial or complete source of power for the tag's circuitry and antenna. Some active RFID transponder tags contain replaceable batteries for years of use; others are sealed units. RFID transponder tag also comes with read-only, write-once-read-many, or read/write capabilities.

Different types of RFID reader had been disclosed in the related art. For example, U.S. Pat. No. 6,362,738 to Vector Vega describes a contactless programmable electrostatic RFID reader that also serves as an Electronic Article Surveillance (EAS) reader. In another example, U.S. Pat. No. 6,523,752 to Hiroyuki Nishitani, et al. reveals a RFID reader/communications apparatus used in delivery sorting of delivery articles such as parcel post and home delivery freight. Another relevant example is U.S. Pat. No. 6,415,978 to Charke W. McAllister that explains a multiple technology data reader for reading barcode labels and RFID tags. In other similar examples, U.S. Pat. No. 6,264,106 to Raj Bridgelall discusses a circuit that combines the functionality of a bar code scanner and a RFID circuit, and U.S. Pat. No. 6,429,776 to Jorge Alicot et al. discusses a reader that integrates EAS device with a barcode scanner to provide complete Point-Of-Sale (POS) operation. Some other examples are Randy W. Watkins discloses a low-power RFID reader that uses two operative to detect and verify the presence of identification tags in U.S. Pat. No. 6,150,948, and Umberto Calari et al. reveals a compact RF reader apparatus integrated into a single compact package structures in U.S. Pat. No. 5,621,100.

Many RFID related systems have also been discussed in the prior art. For example, U.S. Pat. No. 5,822,714 to Robert Thomas Cato describes a data processing system for determining when a portion RFID tags in a real volume cannot be fully access by a RFID reader. Another example, U.S. Pat. No. 5,964,656, Casimir E. Lawler, Jr. et al. discloses a method employing a novel encapsulated RFID device into an improvement animal process system to increase safety and sanitation levels. In another example, U.S. Pat. No. 5,910,776 to Donald Black explains a method and apparatus for identifying, locating, and/or electrical or electronic equipment having electrical plug-type connectors. Another related example is U.S. Pat. No. 6,232,870 to Sharon R. Garber et al. describes devices and applications with particular reference to library materials such as books, periodicals, and magnetic/optical media. Some other examples are Peter J. Quartararo discusses a permanently RFID garment tracking system in U.S. Pat. No. 5,785,181, William M. Maynard explains a RFID tagging system for network assets in U.S. Pat. No. 5,949,335, and Jorge Mon provides the descriptions of a system and method for operator feedback when utilizing RFID reader to find a specific RFID tagged article in U.S. Pat. No. 6,354,493.

Some food safety specific RFID systems are also disclosed in the prior art. U.S. Pat. No. 6,342,839 to Leland D. Curkendall et al. describes an efficient method and apparatus for livestock data collection and management using RFID transponders to identify each animal and a wireless RFID reader to read the animal and event transponder. U.S. Pat. No. 6,211,789 to Courtney A. Oldham et al. and U.S. Pat. No. 6,664,897 to William R. Paper et al. also discusses a system for manual entry data into an integrated electronic database for livestock data collection to provide quality assurance source verification data and performance tracking for individual animal through the product cycle. Although RFID and sensor integrated systems were not discussed in the prior art, several stand-along sensor measuring systems were revealed. U.S. Pat. Nos. 6,503,701, 6,322,963 and 6,342,347, all to Alan Joseph Bauer, presents an invention related to a sensor for analyte detection. The sensor makes use of changes in electrostatic field associated with macromolecular binding agents during their interaction with analytes. Henry R. Pellerin in U.S. Pat. No. 6,411,916 discloses a method of tracking and monitoring the temperature of a food product from point of origin until it is removed from the display case by the consumer for immediate transport to the point of sale. U.S. Pat. Nos. 6,428,748 and 6,576,474, all to Donald F. H. Wallach, explains a detector for monitoring an analyte includes an analyte-sensing composition which has visible color intensity or emission intensity that changes as analyte concentration contacting the detector changes. Evangelyn C. Alocilja et al. in U.S. Pat. No. 6,537,802 reveals a method and apparatus for detection of a small amount of volatile products from a sample using a transducer which changes voltage as a function of contact of the volatile product with the transducer, and John T. McDevitt et al. in U.S. Pat. No. 6,649,403 explains a method for preparing a sensor array formed from a plurality of cavities. In U.S. Pat. No. 6,577,969, Kazumi Takeda et al. also discusses a food safety administration system for controlling safety of food handling locations, and Abtar Singh et al. in U.S. Pat. No. 6,549,135 explains a system to provide for monitoring the food product of a remote retailer via a communication network. RFID readers, RFID tags, sensors and related systems mentioned in the above patents have relatively limited reading range, can detect only the passage of objects at stationary point in a fixed process, and cannot process identification and sensor data concurrently in an effective manner. For less structured processes, an operation must rely on people to place objects within the range of a stationary RFID reader, or a handheld/mobile RFID reader within the range of tags. In either case, a RFID system does not necessarily report an object's current location; rather, it reports the location where object was last seen. Therefore, conventional RFID's tracking capabilities are typically limited to highly structured processes. These limitations make it unsuitable to track many personnel or assets on the move. Typical problems are pallets or containers that are stored in wrong location within a large warehouse or yard, which cannot be found when needed or when a shipment of perishable good is ruined. Other common problems also are expensive tools cannot be located when needed, critical work-in-process cannot be found among hundred of similar-looking items, high-security facilities have no knowledge of personnel movements after individuals clear security checkpoints. RFID readers, RFID tags, sensors and related systems mentioned in the above patents also lack the capabilities of sensing physical parameters of environment, such as temperature, humidity, radiation, gas. In addition, RFID systems mentioned in these patents cannot be used in a control setting where decision and action are made based on real-time sensing and analysis.

To overcome above-mentioned limitation, a need exists for a RFID sensor system that includes multiple RFID readers, RFID-integrated sensor tags, intelligent-agent based software, wireless communication networks, Internet, Intranet, and Extranet links which can process identification, sensing, and location data concurrently, and has wireless communication capabilities among readers, tags and sensors for locating and tracking objects and exchanging data/information among all interested parties.

### OBJECTS AND ADVANTAGES

It is therefore an object of the invention is to provide an Internet-linked RFID Sensor Network system that includes RFID/sensor tags which contain circuitry for identifying, sensing and measuring physical parameters surrounding RFID/senor tags.

Another object of the invention is to provide an Internet-linked RFID Sensor Network system that includes RFID readers, which have a signal strength measurement capability. Multiple antennas located at different positions and attached to the same RFID reader, can measure signal strength transmitted from a single RFID/sensor tag. The signal strength information can be used by a remote location server to calculate RFID/sensor tag's location through multiple signal triangulation.

Another object of this invention is to provide an Internet-linked RFID Sensor Network system that can process multiple wireless RFID/sensor communication protocols. These multiple wireless RFID/sensor communication protocols might include reader-talk-first mode, tag-talk-first mode, EPC (Electronic Product Code)-compatible protocol mode, and Non-EPC compatible protocol mode, and are processed/communicated among RFID readers and RFID/sensor tags.

Another object of this invention is to provide an Internet-linked RFID Sensor Network system that includes RFID readers which contain both landline communication and wireless LAN communication modules to be used either at stationary or mobile position. Stationary RFID readers are used to detect objects passing through a stationary point, while mobile readers attached to a moving vehicle or device, are used to read RFID/sensor tags within the RF reading range of moving path. A real-time location trackable RFID system requires a joint operation of both stationary and mobile RFID readers. To meet these communication needs, a preferred RFID reader shall have external communication links that include both landline communication modules such as USB, or RS232, RS485, and wireless communication modules such as 802.11, 802.15, Bluetooth, or cellular communication network.

Further object of this invention is to provide an Internet-linked RFID Sensor Network system that provides multiple data reading capability. This object allows item attached with RFID/sensor tag to be transited in or transited out of multiple RFID reader's reading ranges, and read by multiple RFID readers at one location or read by multiple RFID readers at multiple locations. This object also allows the identification and sensor data/information of RFID/sensor tags to be maintained in an unifying dataset.

Further object of the invention is to provide an Internet-linked RFID Sensor Network system that includes RFID readers, which contain both wireless Web server and Web client. This object allows concurrent communication and information exchange among RFID readers and RFID/sensor tags within the access range of the iRfidSensorNet. The Web server uses a Hypertext Transmission Protocol (HTTP) to communicate with other RFID readers through landline communication or wireless LAN communication. This preferred RFID reader, with embedded Web server and Web client, also allows reader to be reconfigured from a remote server regarding transmitting/receiving frequencies, communication protocols, or external communication links. It also allows data collected by RFID readers to be accessible by remote clients using a standard Internet browser at anytime and anywhere.

It is an object of the invention to provide an Internet-linked RFID Sensor Network system that has multiple RFID/Sensor tags embedded on the floor or reference point of mobile RFID reader's moving path for identifying the position of mobile RFID reader when it is on the move. RFID/sensor tags, in this case, not only can provide the reference point of mobile RFID reader's position, but also monitor local sensing data and/or traffic information and passing it to the mobile RFID reader.

It is another object of the invention to provide a RFID system that includes both stationary RFID readers and mobile RFID readers. If a RFID reader is at a stationary position, the location of reader is fixed and known. If a RFID reader is at mobile position, the geographic location of reader can be calculated through the reading of RFID/senor tags embedded on RFID reader's moving path or reference points. In a wide area, such as outdoor, where embedded RFID/sensor tags on moving path or reference point are not practical, the signal strength transmitting from RFID reader to multiple Access Point (AP) of wireless LAN communication networks or cellular communication towers can be measured. Through triangulation of four or more APs or cellular communication towers, mobile RFID reader's location can be calculated.

Another object of the invention is to provide an Internet-linked RFID Sensor Network system that includes RFID readers which include an intelligent controller and a plurality of task shared memory to administrate and manage all related application tasks simultaneously. An intelligent controller is responsible for starting and stopping all related application tasks by using the information stored in task shared memory. The intelligent controller is also responsible for installing new application tasks and uninstalling existing application tasks at runtime. The execution of the intelligent controller and all other related application tasks are running under separate parallel execution threads concurrently to fully utilize system's processing power.

It is another object of this invention is to provide an Internet-linked RFID Sensor Network system that can communicate with an intelligent RFID/sensor data monitoring and location tracking system located at a remote location through embedding wireless and landline LAN modules in RFID reader. The intelligent RFID/sensor data monitoring and location tracking system can use these information to calculate the position of RFID/sensor tag and RFID reader using the distance from RFID/sensor tag to RFID reader and the distance from RFID reader to Access Point (APs) of wireless LAN communication networks or cellular communication towers.

It is another object of this invention is to provide an Internet-linked RFID Sensor Network system that allows identification, sensing and location data from RFID/sensor tags to be shared and exchanged at a remote location. Through Internet, Intranet, Extranet links, and a Web-based RFID/sensor data exchange and collaboration system, these information can be accessed by all interested parties, anywhere and anytime, around the world.

### BRIEF DESCRIPTION OF THE DRAWINGS

For a further understanding of the objects and advantages of the present invention, references should be made to the following drawings in conjunction with the accompanying descriptions and operations, wherein:

FIG. 1 is an illustrative block diagram of the Mobile RFID Reader Apparatus with Integrated Wireless LAN RF Front-End Module of the Internet-linked RFID Sensor Network system of this invention;

FIG. 2 is an illustrative block diagram of the Stationary RFID Apparatus Reader without Integrated Wireless LAN RF Front-End Module of the Internet-linked RFID Sensor Network system of this invention;

FIG. 3 is an illustrative block diagram of the Wireless RFID-Integrated Sensor Tag Apparatus of the Internet-linked RFID Sensor Network system of this invention;

FIG. 4 is an illustrative block diagram of the Wireless RFID Tag Apparatus of the Internet-linked RFID Sensor Network system of this invention;

FIG. 5 is an illustrative block diagram of the Wireless Sensor Tag Apparatus of the Internet-linked RFID Sensor Network system of this invention;

FIG. 6 is an illustrative block diagram of the System Software of the Internet-linked RFID Sensor Network system of this invention;

FIG. 7 is an illustrative schematic block diagram of the system operation view of the Internet-linked RFID Sensor Network system of this invention;

FIG. 8 is an illustrative schematic diagram of the warehouse application using multiple Mobile RFID Readers of the Internet-linked RFID Sensor Network system of this invention;

FIG. 9 is an illustrative schematic diagram of the smart shelf application using multiple Stationary RFID Readers of the Internet-linked RFID Sensor Network system of this invention;

FIG. 10 is an illustrative schematic diagram of the RFID/sensor real-time location tracking application using multiple Mobile RFID Readers of the Internet-linked RFID Sensor Network system of this invention;

FIG. 11 is an illustrative schematic diagram of the intelligent RFID/sensor data monitoring and location tracking system for food product safety application of the Internet-linked RFID Sensor Network system of this invention;

FIG. 12 is an illustrates schematic diagram the monitoring and tracking display panel of the intelligent RFID/sensor data monitoring and location tracking system for food product safety application of the Internet-linked RFID Sensor Network system of this invention;

FIG. 13 is an illustrative schematic diagram of the Web-based RFID/sensor data exchange and collaboration system for food product safety application of the Internet-linked RFID Sensor Network system of this invention;

FIG. 14 is an illustrative schematic diagram of the Web-based event-driven data exchange hub of the Web-based RFID/sensor data exchange and collaboration system for food safety application of the Internet-linked RFID Sensor Network system of this invention.

### SUMMARY

An Internet-linked RFID Sensor Network (iRfidSensorNet) system that uses sensors, RFID tags, RFID readers, intelligent-agent-based software, wireless and landline communication networks, and Internet, Intranet, Extranet links for continually identifying, sensing, monitoring, tracking and networking of multiple clusters of objects that are either at stationary location or on the move, and communicating autonomously among these object clusters within the iRfidSensorNet's accessible range. The iRfidSensorNet system comprises a plurality of Wireless RFID/Sensor Tag Apparatus 200 for identifying, sensing and measuring object conditions, and a RFID Reader Apparatus 100 containing System Software 300 that uses an active, real-time concurrent method to process object's conditions and location information for providing an alert to be transmitted to a remote monitoring station for immediate attention.

### Preferred Embodiment—Description

The iRfidSensorNet system comprises a plurality of Wireless RFID/Sensor Tag Apparatus 200 for identify, sensing and measuring objects attached with Wireless RFID/Sensor Tags Apparatus 200, and a RFID Reader Apparatus 100 which contains a System Software 300 that uses an active, real-time monitoring method to process object's conditions and location information to provide an alert that can be transmitted to a remote monitoring station for immediate attention.

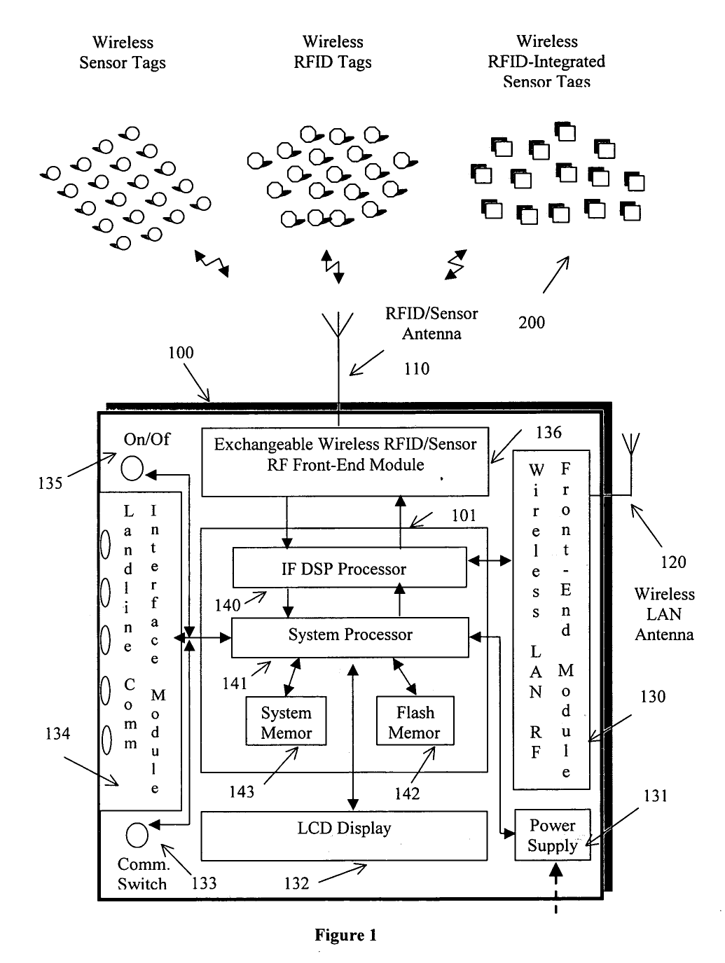

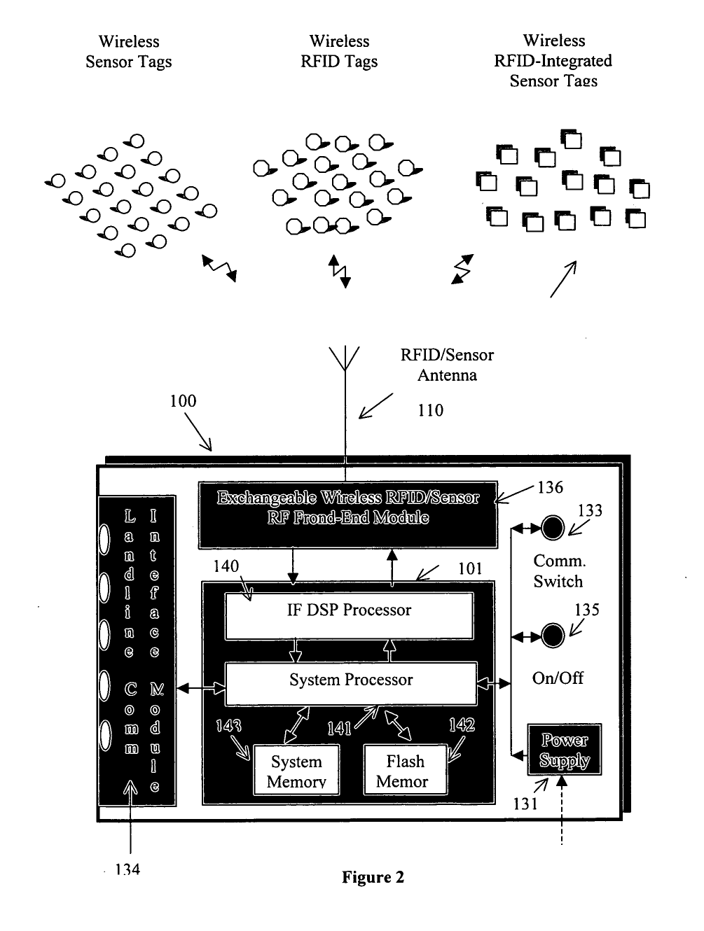

FIG. 1 shows the components of Mobile RFID Reader Apparatus 100 with Integrated Wireless LAN RF Front-End Module of the Internet-linked RFID Sensor Network system of this invention. Main Processing Units 101 contains System Software 300 that uses an active, real-time monitoring method to read and write data from and to RFID/sensor tags, and to communication with main server through either wireless LAN communication network or landline communication network. The key component of Main Processing Unit 101 is System Processor 141 which is connected to IF (Intermediate Frequency) Digital Signal Processing (DSP) Processor 140, Landline Communication Module 134, System Memory 143, Flash Memory 142, On/Off Button 135, Communication Switch 133, and Power Supply 131. Exchangeable Wireless RFID/Sensor RF Front-End Module 136 is responsible for converting analog signal, operating at RFID frequency spectrum, to an Intermediate Frequency (IF). Wireless LAN RF Front-End Module 130 is response for converting analog signal, operating at wireless LAN spectrum to the same Intermediate Frequency (IF) so that IF DSP Processor 140 can process it. Exchangeable Wireless RFID/Sensor RF Front-End Module 136 is connected to a plurality of RFID/Sensor Antenna 110, and means for conducting two-way wireless communication with RFID/Sensor Tags 200. Wireless LAN RF Front-End Module 130 is connected to Wireless LAN Antenna 120, and means for conducting two-way wireless communication with the Access Point (AP) of a wireless LAN communication network. FIG. 2 shows the components of the Stationary RFID Reader Apparatus 200 without Integrated Wireless LAN RF Front-End Module of the Internet-linked RFID Sensor Network system of this invention. It has the same components as FIG. 1, except there is no Wireless LAN RF Front-End Module 130. In this case IF DSP Processor 140 only processes Intermediate Frequency (IF) from RFID/Sensor Tag Apparatus 200.

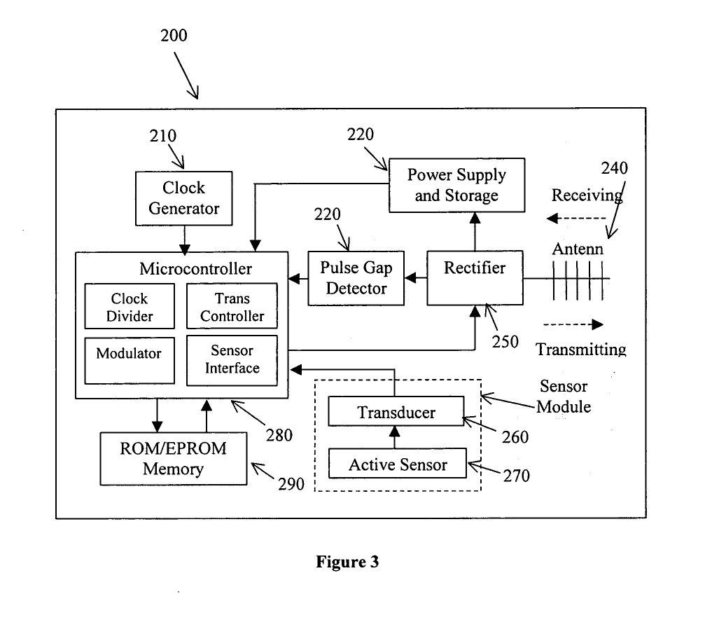

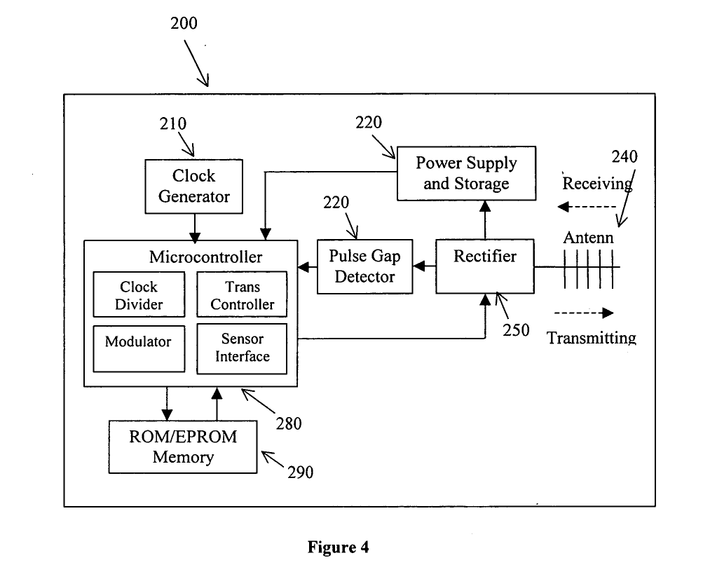

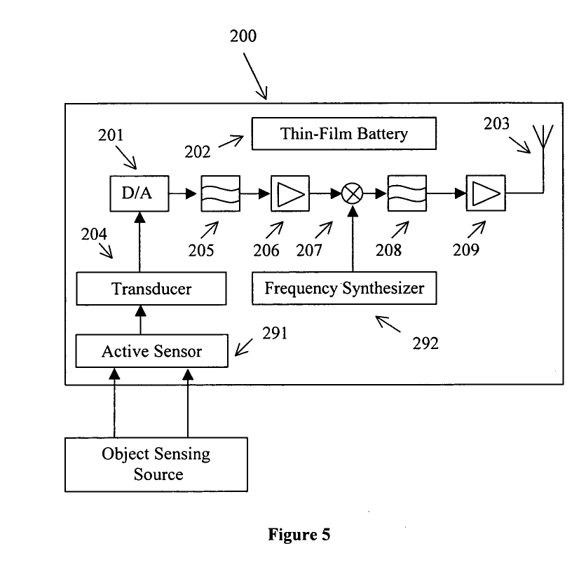

FIG. 3 shows the components of the Wireless RFID-Integrated Sensor Tag Apparatus 200 of the Internet-linked RFID Sensor Network system of this invention. Main component of the RFID-Integrated Sensor Tag Apparatus 200 is Microcontroller 280, which is connected to Clock Generator 210, Pulse Gap Detector 220, ROM/EPROM Memory 290. Microcontroller 280 is also connected to a sensor module that consists of Transducer 260 and Active Sensor 270. Rectifier 250 is connected to Pulse GAP Detector 220, Power Supply and Storage 220. Rectifier 250 is connected to RFID/Sensor Antenna 240, and means for conducting two-way wireless communication between RFID reader and RFID/sensor tag. It also means for receiving electric induction power from remote RFID reader. FIG. 4 shows the components of the Wireless RFID Tag Apparatus 200 of the Internet-linked RFID Sensor Network system of this invention. It has the same components as FIG. 3, except there are no Transducer 260 and Active Sensor 270. FIG. 5 shows the components of the Wireless Sensor Tag Apparatus 200 of the Internet-linked RFID Sensor Network system of this invention. The Wireless Sensor Tag Apparatus 200 contains a RF communication circuitry and uses thin-film battery as a power supply.

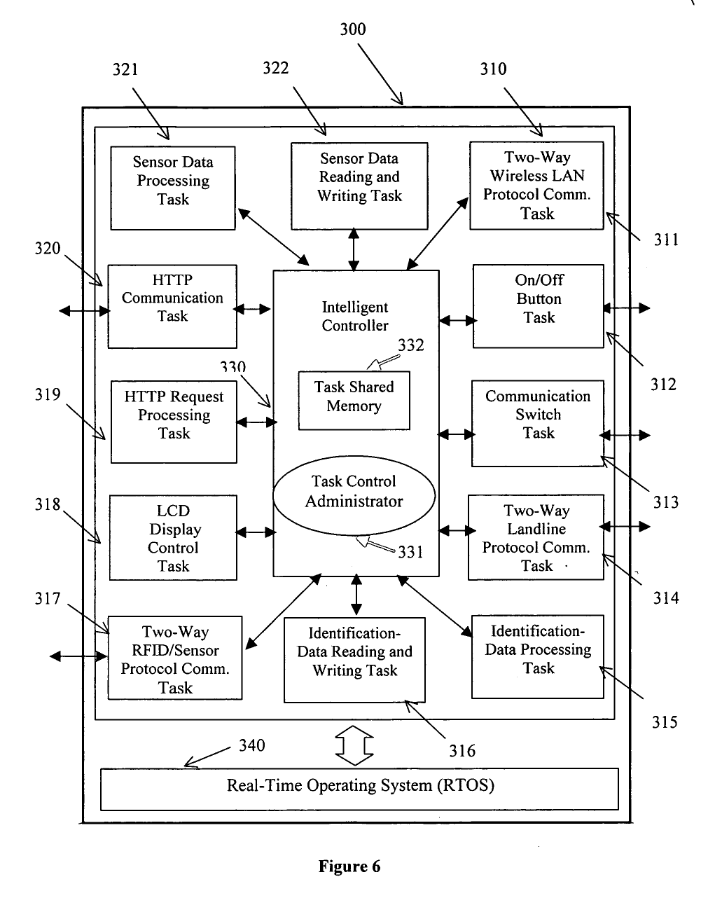

FIG. 6 shows the components of System Software 300 of the Internet-linked RFID Sensor Network system of this invention. Application Tasks of System Software resides in System Processor 141, and run under Real-time Operating System (RTOS) 340. System Software 300 includes Intelligent Controller 330, which comprises Task Control Administrator 331, and a plurality of Task Shared Memory 332. Task Control Administrator 331 manages and controls the execution of application tasks which include Two-Way Wireless LAN Protocol Communication Task 310, On/Off Button Task 312, Communication Switch Task 313, Two-Way Landline Protocol Communication Task 314, Identification Data Processing Task 315, Identification Data Reading and Writing Task 316, Two-Way RFID/Sensor Protocol Communication Task 317, LCD Display Control Task 318, HTTP Request Processing Task 319, HTTP Communication Task 320, Sensor Data Processing Task 321, and Sensor Data Reading and Writing Task 322.

### Preferred Embodiment—Operation

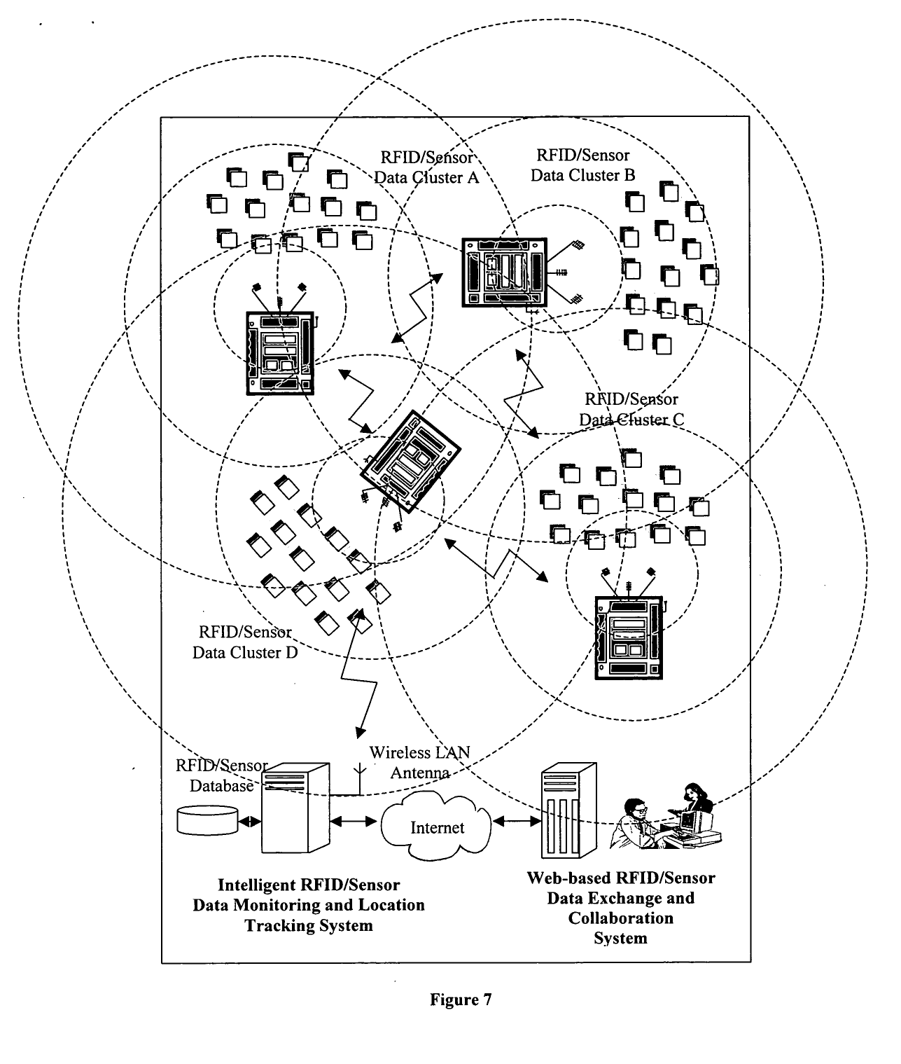

There are many operation configurations of the Internet-linked RFID Sensor Network (iRfidSensorNet) system of this invention. FIG. 7 shows the operation view of the iRfidSensorNet system. Each RFID/sensor data cluster can be read and monitored by multiple RFID readers. For mobile RFID readers that are located too far from the iRfidSensorNet's main server, RFID/sensor data are relayed through nearest mobile RFID reader in order to reach the main server. Two-way communication among all RFID readers allow RFID/sensor tag data, read by multiple RFID readers, to be unified into a single dataset before transmitting to the main server. The iRfidSensorNet's main server includes 1) an intelligent RFID/sensor data monitoring and location tracking system that is linked to multiple RFID readers through either landline communication connection or wireless LAN communication connection, and 2) a Web-based RFID/sensor data exchange and collaboration system that is linked to the intelligent RFID/sensor data monitoring and location tracking system through Internet, Intranet or Extranet.

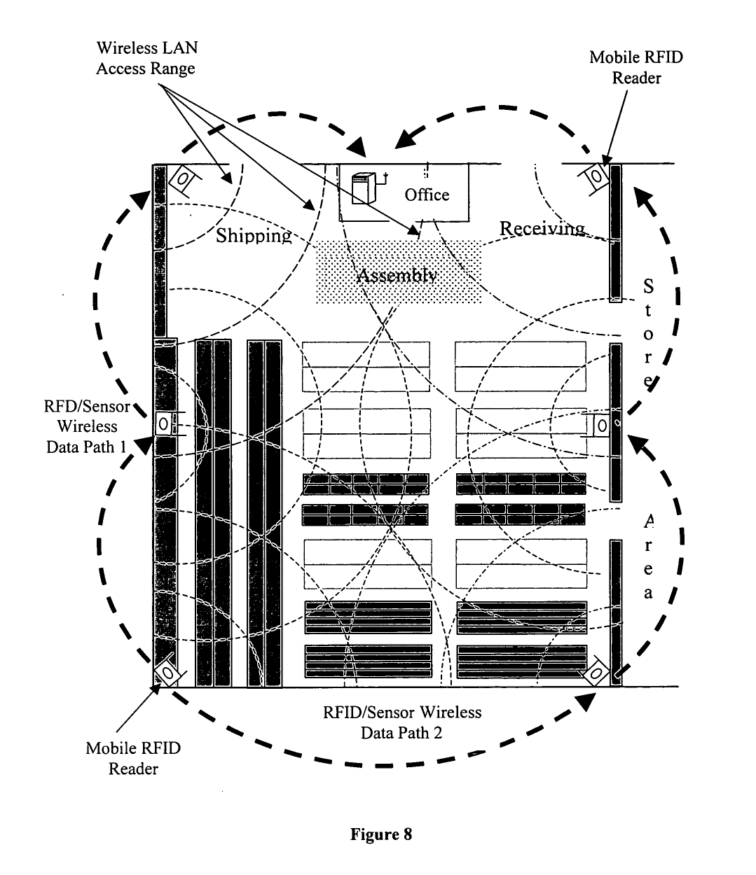

FIG. 8 is an illustrative schematic diagram of the warehouse application using multiple Mobile RFID Readers of the Internet-linked RFID Sensor Network system of this invention. Mobile RFID Reader is mounted on warehouse wall. Wireless LAN access range of each Mobile RFID Reader is overlapped with other RFID readers. Through the overlapped access range, RFID/sensor data from a single tag is unified through two-way communication into a signal dataset first, and then relayed through multiple data path of wireless LAN to the iRfidSensorNet's main server at a remote location.

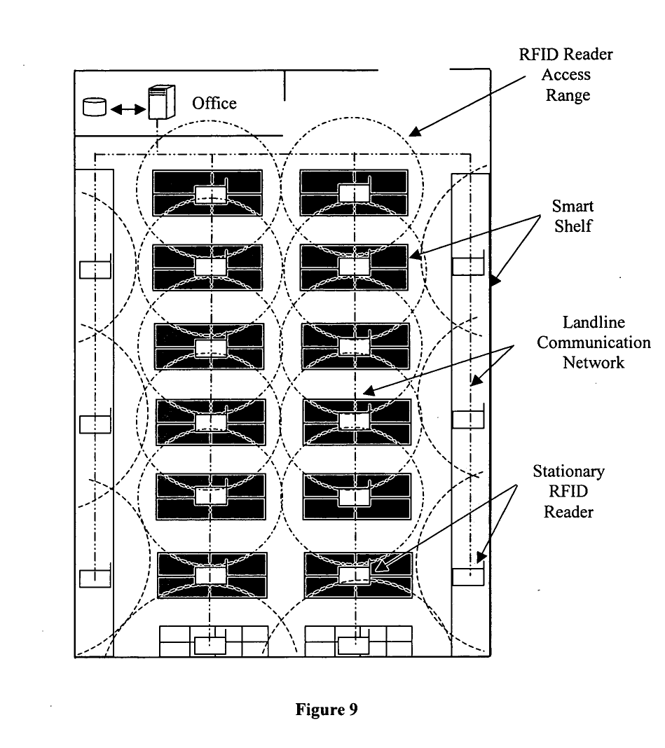

FIG. 9 is an illustrative schematic diagram of the smart shelf application using multiple Stationary RFID Readers of the Internet-linked RFID Sensor Network system of this invention. Stationary RFID Reader is attached to storage self and connected to landline communication network. Access range of RFID/sensor's antenna is overlapped with other antennas. RFID/sensor data from a single tag is unified first, and then relayed to the remote iRfidSensorNet's main server through landline communication connection.

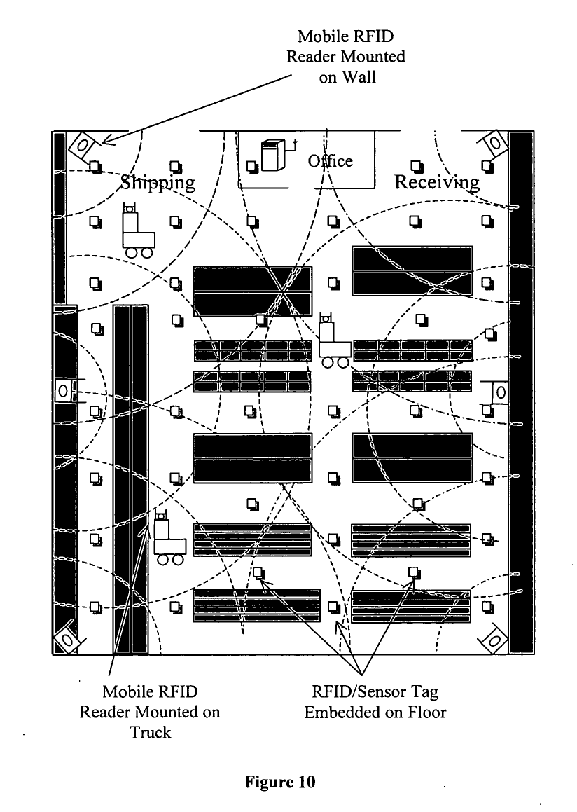

FIG. 10 is an illustrative schematic diagram of the RFID/sensor real-time location tracking application using multiple Mobile RFID Readers of the Internet-linked RFID Sensor Network system of this invention. Mobile RFID Reader are attached to the warehouse as well as mounted on moving truck. In addition, multiple RFID/sensor tags are embedded on warehouse floor and/or reference points. RFID/sensor tags, either at stationary or on the move, are read both by Mobile RFID Reader and/or Stationary RFID reader. With identification and location information from RFID/sensor tags embedded on warehouse floor and/or reference points and the moving speed of vehicle, location of a tag can be calculated and identified.

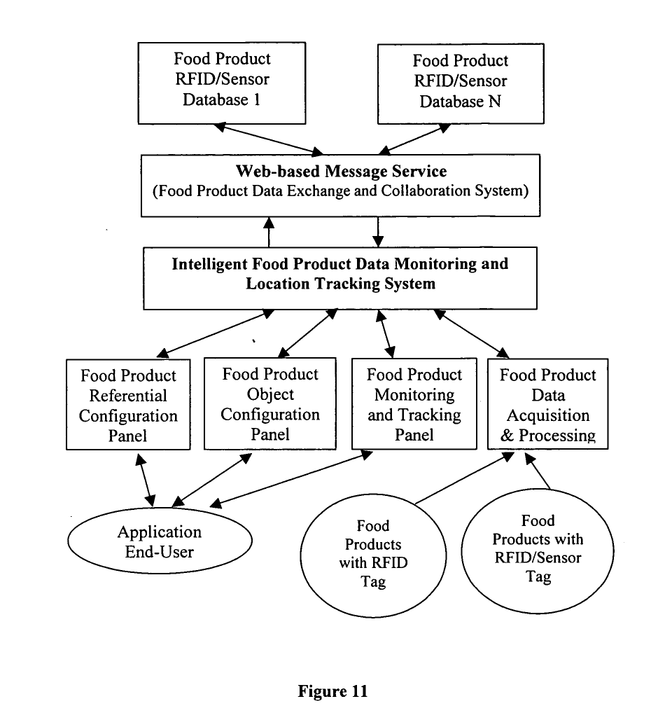

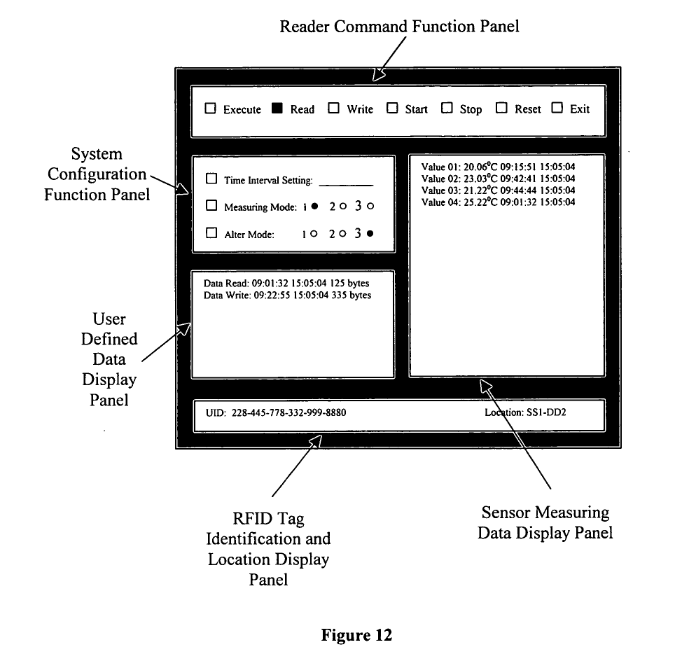

FIG. 11 is an illustrative schematic diagram of the intelligent RFID/sensor data monitoring and tracking system for food product safety application of the Internet-linked RFID Sensor Network system of this invention. Food product data acquisition and processing function of the application handles RFID and sensor data from food product attached with either RFID tag or RFID/sensor tag. Food product referential configuration function of the application allows end-user to specify and configure semantic relationship among all food products, while food product object configuration function of the application can be used by end-user to define detailed product object information. Food product monitoring and tracking function allows application end-user to monitor and control system operation. FIG. 12 illustrates the display panel of this monitoring and tracking function.

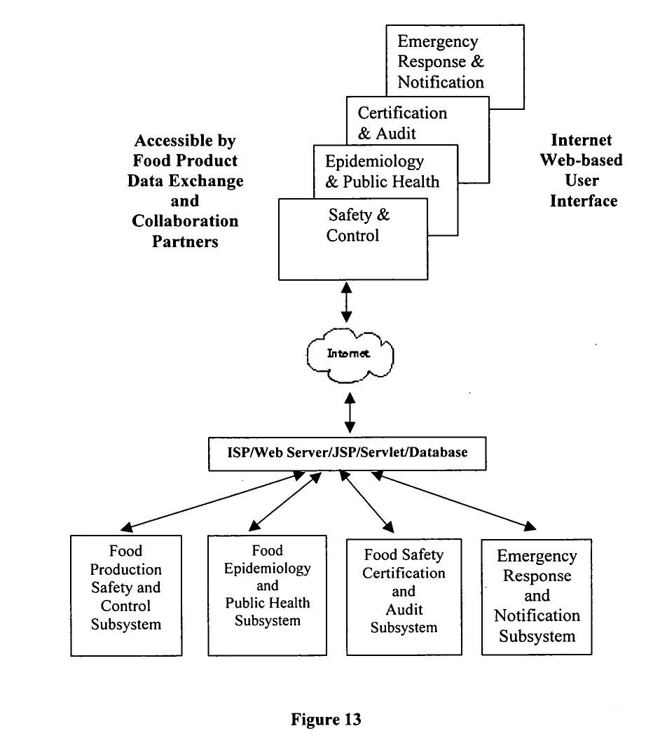

FIG. 13 is an illustrative schematic diagram of the Web-based RFID/sensor data exchange and collaboration system for food product safety application of the Internet-linked RFID Sensor Network system of this invention. In this figure, four subsystems, 1) food production safety and control, 2) food epidemiology and public health, 3) food safety certification and audit, 4) emergency Response and notification, are illustrated. Application end-user can access the Web-based RFID/sensor data exchange and collaboration system through Internet, Intranet or Extranet.

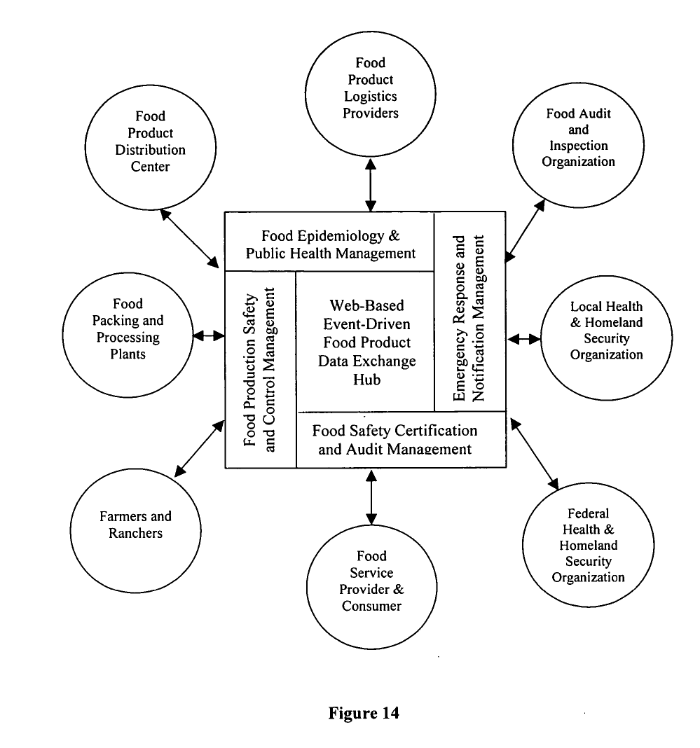

FIG. 14 is an illustrative schematic diagram of the Web-based event-driven data exchange hub of the Web-based RFID/sensor data exchange and collaboration system for food safety application of the Internet-linked RFID Sensor Network system of this invention. The partners, which can access the system data, include framers and ranchers, food packing and processing plants, food product distribution center, food product logistic providers, food audit and inspection organization, local and homeland security organization, federal health and homeland security organization.

What is claimed are:

1. An Internet-linked RFID sensor network (iRfidSensorNet) system comprising of (A) a plurality of RFID/sensor tag apparatus for identifying, sensing and measuring the physical parameters and conditions of an object attached with the said RFID/senor tags apparatus, the said RFID/sensor tag apparatus includes the circuitry of microcontroller, ROM/EPROM memory, pulse gap detector, rectifier, power supply and storage, transducer, active sensor, and (B) a RFID reader apparatus, the said RFID reader apparatus has signal strength measurement capability and contains (1) the circuitry of main processing unit, exchangeable wireless RFID/sensor RF front-end module, wireless LAN RF front-end module, landline communication interface module, LCD display, on/off button, communication switch, power supply, and (2) a system software, the said system software contains an intelligent controller which includes a plurality of task shared memory and a task control administrator, and the said intelligent controller uses an active real-time concurrent method to process application tasks for monitoring, tracking and networking of object's conditions and location information to provide an alert that can be transmitted to a remote monitoring center for immediate attention, and the said application tasks include sensor data processing task, sensor data reading and writing task, two-way wireless LAN protocol communication task, Hypertext Transmission Protocol (HTTP) communication task, HTTP request processing task, on/off button task, communication switch task, two-way landline protocol communication task, LCD display control task, two-way RFID/sensor protocol communication task, identification data reading and writing task, and identification data processing task.

2. The RFID/sensor tag apparatus recited in claim 1, is selected to comprise the RFID-integrated sensor circuitry of:
(a) a microcontroller which includes a clock divider, a modular, a transmission controller, a sensor interface, and means for processing both sensor and RFID data,
(b) a ROM/EPROM memory, and means for storing programs, sensor and RFID data,
(c) a pulse gap detector, and means for detecting signal gap,
(d) a rectifier, and means for rectifying signal gap from a RFID reader,
(e) a power supply and storage, and means for supplying power source for the said RFID/sensor tag apparatus,
(f) an active sensor, and means for detecting physical parameters and conditions of objects,
(g) a transducer, and means for converting physical measurement into an alternative digital form.

3. The RFID/sensor tag apparatus as recited in claim 1, is selected to comprise the RFID only circuitry of:
(a) a microcontroller which includes a clock divider, a modular, a transmission controller, a sensor interface, and means for processing both sensor and RFID data,
(b) a ROM/EPROM memory, and means for storing programs, sensor and RFID data,
(c) a pulse gap detector, and means for detecting signal gap,
(d) a rectifier, and means for rectifying signal gap from a RFID reader,
(e) a power supply and storage, and means for supplying power source for the said RFID/sensor tag apparatus.

4. The RFID/sensor tag apparatus as recited in claim 1, is selected to comprise the sensor only circuitry of:
(a) an active sensor, and means for detecting physical parameters and conditions of objects,
(b) a transducer, and means for converting physical measurement into an alternative digital form,
(c) a digital-to-analog converter, and means for converting digital data from said the transducer to analog signal,
(d) a frequency synthesis, and means for synthesizing signal frequency at wireless communication bandwidth,
(e) a plurality of bandpass filter, and means for band pass filtering signals to desired level,
(f) a plurality of linear power amplifier, and means for amplifying signals to desired level,
(g) a signal mixer, and means for mixing signals to desired level,
(h) a packaged antenna, and means for transmitting short-range radio frequency signals,
(i) a thin-film battery, and means for providing power source of the said wireless sensor apparatus.

5. The RFID reader apparatus as recited in claim 1, is selected to comprise the mobile RFID reader apparatus with integrated wireless LAN RF front-end module circuitry of:
(a) a system processor in the said main processing unit, and means for processing digital signals, interfacing with input/output devices, and conducting system related computations,
(b) an IF DSP processor in the said main process unit, and means for processing intermediate frequency through DSP processor from the said RFID/sensor tags apparatus,
(c) a system main memory in the said main process unit, and means for using as system memory of the said main process unit,
(d) a flash memory in the said main processing unit, and means for storing data from two-way wireless communication processing, RFID and sensor related application tasks of the said main processing unit,
(e) two-way wireless communication RF front-end module, and means for receiving and transmitting wireless signals and protocols, and acquiring signal strength and time-of-arrival data from nearby transmission station,
(f) an exchangeable wireless RFID/sensor RF front-end module, and means for transmitting and receiving signal from the said RFID/sensor tag apparatus,
(g) a LCD display, and means for displaying data of the said RFID reader apparatus,
(h) an on/off button, and means for turning on and off system on the said RFID reader apparatus,
(i) a communication switch, and means for switching between wireless communicating and landline communication mode,
(j) a power supply, and means for supplying power source for the said RFID reader apparatus.

6. The two-way wireless communication RF front-end module as recited in (e) of claim 5, is selected to use one of the following protocol:
(a) global services for mobile (gsm) protocol,
(b) code division multiple access (cdma) protocol,
(c) general packet radio service (gprs) protocol,
(d) cellular digital packet data (cdpd) protocol,
(e) global satellite communication protocol,
(f) bluetooth protocol,
(g) wireless 802.11 protocol,
(h) wireless 802.15 protocol.

7. The RFID reader apparatus as recited in claim 1, is selected to comprise the stationary RFID reader apparatus without integrated wireless LAN RF front-end module circuitry of:
(a) a system processor in the said main processing unit, and means for processing digital signals, interfacing with input/output devices, and conducting system related computations,
(b) an IF DSP processor in the said main process unit, and means for processing intermediate frequency through DSP processor from the said RFID/sensor tags apparatus,
(c) a system main memory in the said main process unit, and means for using as system memory of the said main process unit,
(d) a flash memory in the said main processing unit, and means for storing data from two-way wireless communication processing, RFID and sensor related application tasks of the said main processing unit,
(e) an exchangeable wireless RFID/sensor RF front-end module, and means for transmitting and receiving signal from the said RFID/sensor tag apparatus,
(f) a LCD display, and means for displaying data of the said RFID reader apparatus,
(g) an on/off button, and means for turning on and off system on the said RFID reader apparatus,
(h) a communication switch, and means for switching between wireless communicating and landline communication mode,
(i) a power supply, and means for supplying power source for the said RFID reader apparatus.

8. The system software as recited in claim 1, comprising:
(a) a real-time operating system, and means for executing system start-up, memory configurations, input and output configurations, data file configurations, and system shutdown of said system processor,
(b) an intelligent controller, and means for administrating and managing said related application tasks of said system processor.

9. The intelligent controller as recited in (b) of claim 8, comprising:
(a) a task control administrator for administrating and managing said related application tasks,
(b) a plurality of task shared memory for storing and manipulating data entries of said related application tasks during system execution.

10. The task control administrator as recited in (a) of claim 9, comprising:
(a) a plurality of control rules, and means for describing control instructions of said related application tasks,
(b) a rule engine, and means for executing said control rules.

11. The intelligent controller as recited in (b) of claim 8 administrate and manage of said related application tasks of:
(a) a sensor data processing,
(b) a sensor data reading and writing task,
(c) a two-way wireless LAN protocol communication task,
(d) a Hypertext Transmission Protocol (HTTP) communication task,
(e) a HTTP request processing task,
(f) a on/off button task,
(g) a communication switch task,
(h) a two-way landline protocol communication task,
(i) a LCD display control task,
(j) a two-way RFID/sensor protocol communication task,
(k) an identification data reading and writing task,
(l) an identification data processing task.

12. The Internet-linked RFID sensor network system as recited in claim 1, can measure signal strength of the RFID/sensor tag apparatus comprising the method of:
(a) multiple antennas attached at different positions of the said RFID reader apparatus,
(b) transmitting signal to the said RFID/sensor tag apparatus,
(c) measuring signal strength transmitted from the said RFID/sensor tag apparatus.

13. The Internet-linked RFID sensor network system as recited in claim 1, can process multiple wireless RFID/Sensor communication protocols among the said RFID readers apparatus and the said RFID/sensor tags apparatus using the said exchangeable wireless RFID/sensor RF front-end module comprising the method of:
(a) using reader-talk-first tag processing mode,
(b) using tag-talk-first processing mode,
(c) using EPC (Electronic Product Code)-compatible protocol processing mode,
(d) using non-EPC compatible protocol processing mode.

14. The Internet-linked RFID sensor network system as recited in claim 1, can provide both landline and wireless LAN communication capability comprising the method of:
(a) including the said RFID reader apparatus containing landline of USB, or RS232, RS485 communication ports,
(b) including wireless LAN RF front-end module containing of 802.11, 802.15, Bluetooth, or cellular communication network protocols,
(c) installing the stationary RFID reader apparatus at stationary location for detecting objects passing through stationary point,
(d) installing the said mobile RFID reader apparatus attached to moving vehicle or device to read the said RFID/sensor tag apparatus within the reading range of a moving path,
(e) tracking real-time location of the said RFID/sensor tag apparatus using joint operation of the said stationary RFID reader apparatus and the said mobile RFID reader apparatus,

15. The Internet-linked RFID sensor network system as recited in claim 1, can provide multiple data reading functions comprising the method of:
(a) allowing item with the said RFID/sensor tags apparatus attached to be transited in or out of multiple the said RFID reader apparatus ranges,
(b) allowing item with the said RFID/sensor tags apparatus attached to be read by multiple the said RFID reader apparatus at single location,
(c) allowing item with the said RFID/sensor tags apparatus attached to be read by multiple the said RFID reader apparatus at multiple locations,
(d) being able to maintain identification and sensor information of the said RFID/sensor tag apparatus in an unifying dataset.

16. The Internet-linked RFID sensor network system as recited in claim 1, can maintain concurrent communication and data/information exchange comprising the method of:
(a) containing both wireless Web server and Web client at the said RFID reader apparatus,
(b) maintaining concurrent communication and data/information exchange among the said RFID readers apparatus and the said RFID/Sensor tags apparatus within the access range of the said RFID reader apparatus and the said wireless LAN RF front-end module,
(c) allowing the said RFID reader apparatus to be reconfigured from a remote server regarding transmitting/receiving frequencies, communication protocols, or external communication links,
(d) allowing data collected by the said RFID readers apparatus to be accessible by remote clients with a standard browser at anytime and anywhere.

17. The Internet-linked RFID sensor network system as recited in claim 1, can provide local data and position of the said mobile RFID reader apparatus through embedding the said RFID/sensor tag apparatus on floor path or reference point comprising the method of:
(a) embedding multiple the said RFID/sensor tags apparatus on the floor or reference point of the said mobile RFID reader's moving path
(b) detecting the position of the said mobile REID reader apparatus when it is on the move,
(c) monitoring local sensing data for the said RFID reader apparatus passing through reference point,
(d) monitoring traffic data/information for the said RFID reader apparatus passing through reference point.

18. The Internet-linked RFID sensor network system as recited in claim 1, can provide the real-time location of the said RFID reader apparatus comprising the method of:
(a) including both the said stationary RFID reader apparatus and the said mobile RFID reader apparatus,
(b) determining the said RFID reader apparatus' location when the said RFID reader apparatus is at fixed position,
(c) determining the said RFID reader apparatus' location when the said RFID reader apparatus is at local area mobile position, through calculating the reading of location of tags embedded on RFID reader apparatus' moving path or reference points,
(d) determining the said RFID reader's location when the said RFID reader is at wide area mobile position through triangulation of at least three Access Point (AP) or cellular communication towers.

19. The Internet-linked RFID sensor network system as recited in claim 1, can communicate with an intelligent RFID/sensor data monitoring and location tracking system at a remote center comprising the method of:
(a) embedding the said landline communication interface module in the said RFID reader apparatus,
(b) embedding wireless LAN RF front-end modules in the said RFID reader apparatus,
(c) calculating the position of the said RFID/Sensor tag and the said RFID reader using the distance from the said RFID/sensor tag apparatus to the said RFID reader apparatus and the distance from the said RFID reader apparatus to Access Point (APs) of the said wireless LAN communication networks towers,
(d) transmitting local sensing and positing data to the said remote center.

20. The Internet-linked RFID sensor network system as recited in claim 1, can share and exchange RFID/sensor data/information at the said remote center comprising the method of:
(a) including Internet, Intranet, Extranet links,
(b) including Web-based RFID/Sensor data exchange and collaboration system server,
(c) allowing information to be accessed by all interest parties through standard Internet browser.
